(19) United States
(12) Patent Application Publication
(10) Pub. No.: US 2021/0121370 A1
(43) Pub. Date: Apr. 29, 2021

(54) Pacifier Strap with Wireless Locator

(71) Applicants: Keith Lehman, Syracuse, IN (US); Jenell Lehman, Syracuse, IN (US)

(72) Inventors: Keith Lehman, Syracuse, IN (US); Jenell Lehman, Syracuse, IN (US)

(21) Appl. No.: 17/076,196

(22) Filed: Oct. 21, 2020

Related U.S. Application Data
(60) Provisional application No. 62/925,331, filed on Oct. 24, 2019.

(51) Int. Cl. A61J 17/00; H04B 1/3827; G01S 19/01

(52) U.S. Cl. CPC A61J 17/101; A61J 17/1115; A61J 2205/60; G01S 19/01; H04B 1/3827

(57) ABSTRACT

A pacifier strap with a wireless locator is provided. The device includes a flexible strap having a first end opposite a second end. A fastener is disposed on the first end of the flexible strap. A connector is disposed on the second end of the flexible strap, wherein the connector can removably secure a pacifier thereon. An electronics housing is disposed within the flexible strap, wherein a power source is disposed within the electronics housing and is operably connected to a wireless transceiver. The wireless transceiver can transmit a location of the flexible strap to a remote device. In some embodiments, the pacifier is permanently affixed to the second end of the flexible strap.

### CROSS REFERENCE TO RELATED APPLICATIONS

This application claims the benefit of U.S. Provisional Application No. 62/925,331 filed on Oct. 24, 2019. The above identified patent application is herein incorporated by reference in its entirety to provide continuity of disclosure.

### BACKGROUND OF THE INVENTION

The present invention relates to pacifier straps. More particularly, the present invention pertains to pacifier straps having a wireless location device therein.

Many infants and toddlers have a favorite or frequently used item or toy, such as a pacifier, teething ring, or other item. In order to keep the item close at hand, many parents use a tether system to attach the desired item to a child's seat, stroller, or clothing for ready access. Furthermore, the tether system reduces the risk of misplacing the favorite item. However, when disconnected from the child, the tether system itself can still be easily misplaced. This can lead to frantic searches to find the one item that could possibly soothe an upset child. Therefore, there is a desire for a device that can allow a user to easily and efficiently locate a misplaced children's item tether system.

In light of the devices disclosed in the known art, it submitted that the present invention substantially diverges in design elements from the known art and consequently it is clear that there is a need in the art for an improvement to existing pacifier straps. In this regard, the instant invention substantially fulfills these needs.

### SUMMARY OF THE INVENTION

In view of the foregoing disadvantages inherent in the known types of pacifier straps now present in the known art, the present invention provides a pacifier strap having a wireless locator wherein the same can be utilized for providing convenience for the user when locating a misplaced pacifier strap.

The present system comprises a flexible strap having a first end opposite a second end. A fastener is disposed on the first end of the flexible strap and a connector is disposed on the second end of the flexible strap. The connector is configured to removably secure a pacifier thereto. An electronics housing is disposed within the flexible strap. A power source is disposed within the electronics housing and is operably connected to a wireless transceiver. The wireless transceiver is configured to transmit a location of the flexible strap to a remote device. In some embodiments, the pacifier is permanently affixed to the connector.

In another embodiment, the electronics housing is disposed within the flexible strap adjacent to the first end. In other embodiments, the fastener comprises a spring-biased clip having an upper panel and a lower panel selectively movable between an open position and a closed position, wherein the closed position, the upper panel rests flush against the lower panel. In yet another embodiment, a plurality of teeth are disposed along an interior surface of each of the upper and lower panels. In some embodiments, a speaker is disposed within the electronics housing, wherein the speaker is configured to emit an audio signal when the wireless transceiver receives an actuation signal from the remote device. In another embodiment, a charging port is disposed in the electronics housing, wherein the charging port is operably connected to the power source. In other embodiments, a D-ring is pivotally affixed to the first end of the flexible strap, wherein the fastener is affixed to the D-ring. In yet another embodiment, a GPS system is disposed within the electronics housing, wherein the GPS system determines the location of the flexible strap relative to the remote device. In some embodiments, the connector comprises a carabiner. In another embodiment, the connector comprises a looped cord. In some embodiments where the pacifier is permanently affixed to the connector, the connector comprises a cord stitched to the second end defining a loop, wherein the pacifier is secured within the loop.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the pacifier strap with wireless locator.

FIG. 2 shows a close-up view of an embodiment of the fastener of the pacifier strap with wireless locator.

FIG. 3 shows a close-up view of the pacifier connector of an embodiment of the pacifier strap with wireless locator.

FIG. 4 shows a wiring diagram of the electronic components of an embodiment of the pacifier strap with wireless locator.

### DETAILED DESCRIPTION OF THE INVENTION

Reference is made herein to the attached drawings. Like reference numerals are used throughout the drawings to depict like or similar elements of the pacifier strap with wireless locator. For the purposes f brevity, the following disclosure and associated figures describe the use of the wireless locator strap with a pacifier, however alternate embodiments contemplate the use of the strap with various alternate items, such as toys, teething rings, or the like. The figures are intended for representative purposes only and should not be considered to be limiting in any respect.

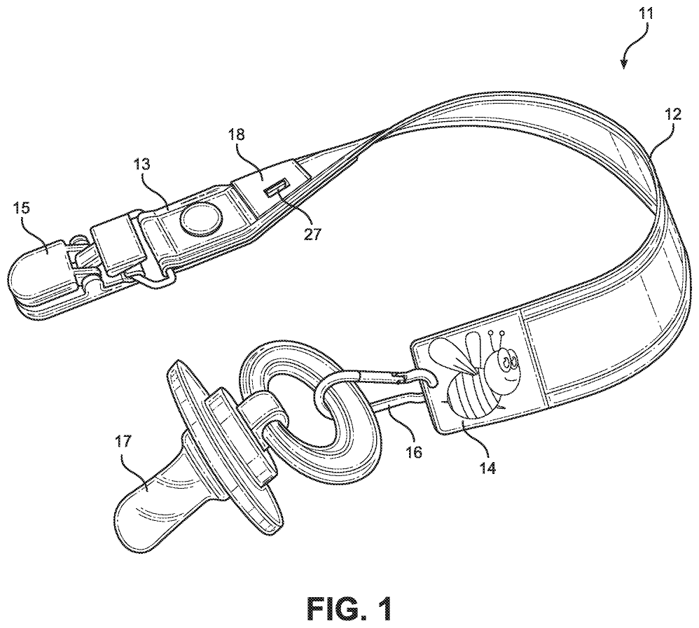

Referring now to FIG. 1, there is shown a perspective view of an embodiment of the pacifier strap with wireless locator. The pacifier strap with wireless locator 11 comprises a flexible strap 12 having a first end 13 opposite a second end 14. A fastener 15 is affixed to the first end 13, wherein the fastener 15 is configured to removably secure the flexible strap 12 to a desired object or article of clothing. In this manner, the flexible strap 12 can be used to tether a child's favorite item or toy, such as a pacifier 17, to the desired object or article of clothing in the vicinity of the child. This allows the user to minimize the risk of the pacifier 17 from being dropped or misplaced by the child. A connector 16 is affixed to the second end 14, wherein the connector 16 is configured to secure the pacifier 17 or another item to the flexible strap 12. In the shown embodiment, the connector 16 comprises a carabiner having a spring-biased latch, wherein the user can removable secure various items to the flexible strap 12. In this manner, the user can tether interchangeable items to a child or the immediate area of the child to minimize the risk of the item being lost or misplaced. In alternate embodiments, the connector 16 can comprise a variety of other securement devices, including looped cord to permanently affix the pacifier 17 or another item to the flexible strap 12, as shown elsewhere herein. The flexible strap 12 is contemplated to be comprised of a variety of materials commensurate with flexibility and durability, including fabric, leather, silicone, or the like.

An electronics housing 18 is disposed within the flexible strap 12, wherein the electronics housing 18 contains a variety of electronic components as discusses elsewhere herein. In the shown embodiment, the electronics housing 18 is disposed between an upper layer and a lower layer of the flexible strap 12, such that the electronics housing 18 is permanently affixed within the flexible strap 12. In the shown embodiment, the electronics housing 18 further comprises a charging port 27 therein, wherein the charging port 27 extends through the flexible strap 12. In the shown embodiment, the charging port 27 comprises a USB port, however, in alternate embodiments, other power transfer means, such as wireless and conducting charging are contemplated. In the illustrated embodiment, the electronics housing 18 is disposed adjacent to the first end 13. As the second end 14 secures a pacifier 17, teething ring, or other item that may frequently come in contact with saliva, food, beverages, or other objects harmful to electronic components, this placement ensures that the potentially vulnerable electronic components within the electronics housing 18 are kept away from the second end 14. In an alternate embodiment, the electronics housing 18 comprises a waterproof housing to prevent damage to the electronic components therein.

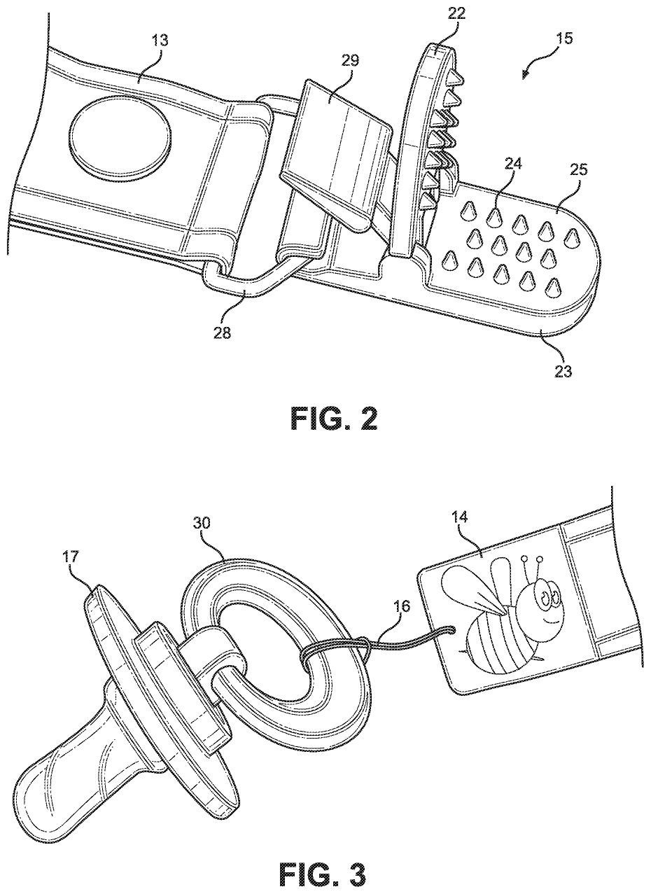

Referring now to FIG. 2, there is shown a close-up view of an embodiment of the fastener of the pacifier strap with wireless locator. In the illustrated embodiment, the fastener 15 comprises a spring-biased clip having an upper panel 22 and a lower panel 23 selectively movable between an open position and a closed position. When in the closed position, the upper panel 22 and the lower panel 23 rest flush against each other, such that an object can be frictionally engaged therebetween. In the shown embodiment the upper and lower panels 22, 23 are movable upon actuation of a lever 29 disposed on the fastener 15. Furthermore, in the illustrated embodiment each of the upper and lower panels 22, 23 include a plurality of teeth 24 across an interior surface 25 thereof, wherein the plurality of teeth 24 are configured to increase the surface area in contact with an object secured between the upper and lower panels 22, 23, thereby increasing frictional engagement. In the shown embodiment, the plurality of teeth 24 are disposed across an entirety of the interior surface in a plurality of offset rows, wherein the offset allows the plurality of teeth 24 on the opposing panel to fit between the plurality of teeth 24 of the remaining panel in the closed position. Additionally, in the illustrated embodiment, the plurality of teeth 24 each comprise a rounded distal end, such that the risk of injury due to the fastener 15 closing on a user is reduced.

In the illustrated embodiment, the first end 13 comprises a looped piece of fabric securing a D-ring 28 therein. In some embodiments, the looped piece of fabric is removably securable to the flexible strap, such that the D-ring 28 can be removed from the first end 13 and replaced with an alternate fastener 15. The D-ring 28 is pivotally secured to the first end 13, thereby allowing the fastener 15 affixed to the D-ring 28 to maneuver about the first end 13 as external forces are applied. In this manner, the fastener 15 is retained on the article of clothing or other object while an attached pacifier is in use without becoming disengaging from the article of clothing when dropped, pulled, or otherwise moved during use.

Referring now to FIG. 3, there is shown a close-up view of the pacifier connector of an embodiment of the pacifier strap with wireless locator. In the illustrated embodiment, the pacifier 17 is permanently affixed to the second end 14 of the flexible strap via the connector 16. In the shown embodiment, the connector 16 comprises a looped cord stitched to the second end 14 on opposing ends thereof, thereby defining a loop therebetween. In some embodiments, a handle 30 of the pacifier 17 is disposed through the loop, such that the pacifier 17 is permanently affixed to the second end. In the shown embodiment, the connector 16 is fed through the handle 30 and looped over the opposing ends thereof before the connector 16 is stitched into h second end 14. In this manner, the pacifier 17 can be permanently affixed to the second end 14. Furthermore, in the illustrated embodiment, the second end 14 further comprises an indicia thereon. In some embodiments, the indicia can vary across multiple pacifier strap systems, such that the user can readily identify which pacifier strap is associated with a particular child or favorite item. Furthermore, should the user possess multiple pacifier straps with wireless locators, the indicia can be utilized to identify which pacifier strap to activate the location tracking system of, as further described elsewhere herein.

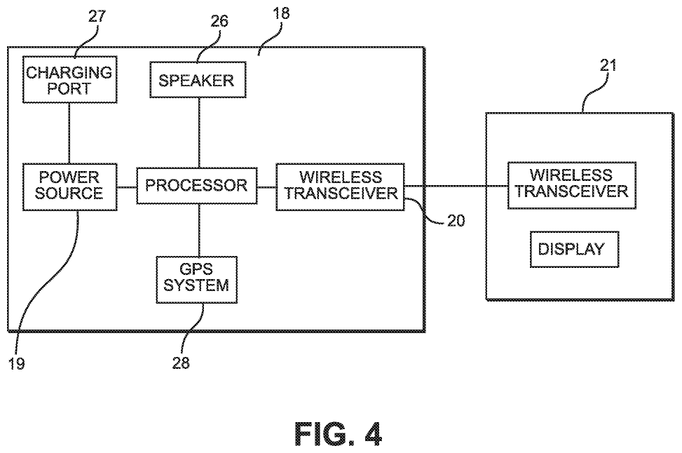

Referring now to FIG. 4, there is shown a wiring diagram of the electronic components of an embodiment of the pacifier strap with wireless locator. In the illustrated embodiment, the electronics housing 18 comprises a plurality of electronic components therein, including a power source 19 operably connected to a wireless transceiver 20. The power source 19 is further operably connected to the charging port 27, such that the user can selectively transfer power to the power source 19 as desired. The wireless transceiver 20 is configured to wirelessly communicate with a remote device 21, such as a mobile phone, computer, laptop, tablet, or the like. When a user actuates the remote device 21, such as via an input programmed into an associate application, an actuation signal is transmitted to the wireless transceiver 20 of the electronics housing 18 activating one or more of several possible location systems. In this manner, the user can readily locate a misplaced pacifier strap. In the shown embodiment, the wireless transceiver is further operably connected to a processor configured to selectively activate one or more of the location systems.

In the shown embodiment, one such location system is a speaker 26 disposed within the electronics housing 18, wherein the speaker 26 is configured to emit an audio signal upon receipt of the actuation signal from the remote device 21. The audio signal can comprise a variety of audible notifications, such as beeping, an alarm, or the like, such that the user can locate the device by following the audio signal to the source. Additionally, in the shown embodiment, the processor may activate a GPS system 28 disposed within the electronics housing 18, wherein the GPS system 28 is configured to transmit a location of the pacifier strap relative to the position of the remote device 21. In this manner, the user can readily determine the location of the misplaced pacifier strap. In some such embodiments, the remote device 21 may further display a map indicating the position of the electronics housing 18 relative to the remote device 21. In this way, the user can follow the map to locate the misplaced pacifier strap.

It is therefore submitted that the instant invention has been shown and described in various embodiments. It is recognized, however, that departures may be made within the scope of the invention and that obvious modifications will occur to a person skilled in the art. With respect to the above description then it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A pacifier strap with wireless locator, comprising:
a flexible strap having a first end opposite a second end;
a fastener disposed on the first end of the flexible strap;
a connector disposed on the second end of the flexible strap;
wherein the connector is configured to removably secure pacifier thereon;
an electronics housing disposed within the flexible strap;
a power source disposed within the electronics housing, wherein the power source is operably connected to a wireless transceiver;
wherein the wireless transceiver is configured to transmit a location of the flexible strap to a remote device.

2. The pacifier strap with wireless locator of claim 1, wherein the electronics housing is disposed within the flexible strap adjacent to the first end.

3. The pacifier strap with wireless locator of claim 1, wherein the fastener comprises a spring-biased clip having an upper panel and a lower panel selectively movable between an open position and a closed position, wherein the closed position, the upper panel rests flush against the lower panel.

4. The pacifier strap with wireless locator of claim 3, further comprising a plurality of teeth extending from an interior surface of each of the upper panel and the lower panel.

5. The pacifier strap with wireless locator of claim 1, further comprising a speaker disposed within the electronics housing, wherein the speaker is configured to emit an audio signal when the wireless transceiver receives an actuation signal from the remote device.

6. The pacifier strap with wireless locator of claim 1, further comprising a charging port disposed in the electronics housing, the charging port operably connected to the power source.

7. The pacifier strap with wireless locator of claim 1, further comprising a D-ring pivotally secured to the first end of the flexible strap, wherein the fastener is affixed to the D-ring.

8. The pacifier strap with wireless locator of claim 1, further comprising a GPS system within the electronics housing, wherein the GPS system determines the location of the flexible strap relative to the remote device.

9. The pacifier strap with wireless locator of claim 1, wherein the connector comprises a carabiner.

10. The pacifier strap with wireless locator of claim 1, wherein the connector comprises a looped cord.

11. A pacifier strap with wireless locator, comprising:
a flexible strap having a first end opposite a second end;
a fastener disposed on the first end of the flexible strap;
a connector disposed on the second end of the flexible: strap;
a pacifier permanently affixed to the connector;
an electronics housing disposed within the flexible strap;
a power source disposed within the electronics housing, wherein the power source operably connected to a wireless transceiver;
wherein the wireless transceiver is configured to transmit a location of the flexible strap to a remote device.

12. The pacifier strap with wireless locator of claim 11, wherein the electronics housing is disposed within the flexible strap adjacent to the first end.

13. The pacifier strap with wireless locator of claim 11, wherein the fastener comprises a spring-biased clip having an upper panel and a lower panel selectively movable between an open position and a closed position, wherein the closed position, the upper panel rests flush against the lower panel.

14. The pacifier strap with wireless locator of claim 13, further comprising a plurality of teeth extending from an interior surface of each of the upper panel and the lower panel.

15. The pacifier strap with wireless locator of claim 11, further comprising a speaker disposed within the electronics housing, wherein the speaker is configured to emit an audio signal when the wireless transceiver receives an actuation signal from the remote device.

16. The pacifier strap with wireless locator of claim 11, further comprising a charging port disposed in the electronics housing, the charging port operably connected to the power source.

17. The pacifier strap with wireless locator of claim 11, further comprising a D-ring pivotally secured to the first end of the flexible strap, wherein the fastener is affixed to the D-ring.

18. The pacifier strap with wireless locator of claim 11, further comprising a GPS system within the electronics housing, wherein the GPS system determines the location of the flexible strap relative to the remote device.

19. The pacifier strap with wireless locator of claim 11, wherein the connector comprises a cord stitched to the second end defining a loop, wherein the pacifier is secured within the loop.
